(19) United States
(12) Patent Application Publication
(10) Pub. No.: US 2005/0223103 A1
(43) Pub. Date: Oct. 6, 2005

(54) Management system, management method and program

(75) Inventors: Kanji Hozumi, Kawasaki (JP); Naoki Yuzawa, Kawasaki (JP); Yuuichi Abe, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/920,231

(22) Filed: Aug. 18, 2004

(30) Foreign Application Priority Data
Mar. 30, 2004 (JP) 2004-098743

(51) Int. Cl. G06F 15/16

(52) U.S. Cl. 709/229

(57) ABSTRACT

A mail server 302 calculates a reject priority for every mail source address of an E-mail on the basis of a date/time when receiving the E-mail from a sender terminal 100, further, the mail server 302, if a mail source address of the mail which should be rejected, count of the E-mails exceeds a registerable mail address count in a receipt reject address list 304, executes control to register the mail addresses having higher reject priorities preferentially in the receipt reject address list 304.

### BACKGROUND OF THE INVENTION

The invention relates to a management system for managing communication partner terminals that should be rejected in various categories of communications as by E-mails, telephones, FAX and so forth.

Problems about existences of E-mails of which receipts are not desired by users, which are so-called nuisance E-mails transmitted to, e.g., an unspecified majority of mobile terminals, have hitherto arisen, and the users demanded countermeasures against those E-mails. In order to meet such a request, each of mobile communication common carriers has a function of managing a [receipt reject address list] registered with mail addresses which users reject receiving from and rejects the receipt of the E-mail having a mail source address registered in this receipt reject address list at a mail center for accepting E-mails addressed respective mobile terminals.

Proposed for the mail address management was a technology of updating an address book in a way that deletes low-availability mail addresses as occasion demands by way of a method of updating the address book registered with the mail addresses used for sending the E-mails (refer to, e.g., Patent document 1).

[Patent document 1]

Japanese Patent Application Laid-Open Publication No. 11-122416

### SUMMARY OF THE INVENTION

As for registering in the receipt reject address list, however, the user himself or herself performs an operation of registering an address of the received E-mail, and therefore the following problem arises. To be specific, an address count of the mail addresses registerable in the receipt reject address list is normally limited to, e.g., 20, etc., and hence the users have a request for registering the receipt reject address list preferentially with predetermined mail addresses as source addresses of recent nuisance mails. Such a request could not yet be met.

Further, a conventional mail address management method described above is related to updating the address book registered with the mail addresses used for sending the E-mails, and further shows no substantial limit of the address count of the mail addresses registerable in the address book. For this reason, the conventional mail address management method can not be applied as it is to the rejection of receiving the nuisance mails in the case of limiting the registered address count of the mail addresses as receipt reject targets.

Moreover, there exist a plurality of senders who send the nuisance mails, or the nuisance mail sender sends the nuisance mails many times in a way that changes the mail address. It is therefore difficult for the user to memorize which mail address registered in the receipt reject address list is new or old, and it is not easy to memorize even whether the mail address was registered or not. Moreover, the user is unable to recognize whether or not the E-mail having the mail address registered in the receipt reject address list is to be delivered afterward. The user can not therefore grasp a trigger of deleting, out of the receipt reject address list, the mail addresses from which the none of the nuisance mails have been sent. As a result, there is a possibility that the mail addresses with no necessity of being registered in the receipt reject address list might continue to be registered.

The invention was devised to solve the problems of the prior art and aims at providing a management system capable of properly managing the communication partner terminals which should be rejected in the communications.

A management system for managing communication partner terminals which should be rejected in communications according to the invention, includes a retaining unit retaining pieces of identifying information of the communication partner terminals which should be rejected in the communications for predetermined number of cases, a priority setting unit setting, when a predetermined operation corresponding to a receipt rejection is performed, a receipt reject priority of the communication partner terminal's identifying information associated with the predetermined operation on the basis of a timestamp of the communication with the communication partner terminal, and an identifying information registering unit retaining the retaining unit with the identifying information of the communication partner terminals for the predetermined number of cases in the order of descending the receipt reject priorities.

With this configuration, the retaining unit is stored with the identifying information, exhibiting the higher priorities, of the communication partner terminal for the predetermined session count according to the receipt reject priorities based on the communication timestamps. Therefore, for example, it is possible to properly manage, based on the communication timestamps, the communication partner terminals which should be rejected in the communications by retaining preferentially the identifying information of the predetermined communication partner terminal that shows the latest communication timestamp, and so forth.

Further, in the A management system according to the invention, the priority setting unit includes a calculation unit calculating numerical values associated with plural pieces of timestamps of communications with the communication partner terminals, and the identifying information registering unit retains the retaining unit with the identifying information of the communication partner terminal corresponding to the predetermined operation for the predetermined number of the cases on the basis of the numerical value associated with the timestamp of communication.

Moreover, in the management system according to the invention, the retaining unit fixedly retains the identifying information of the communication partner terminals which should be rejected, and the priority setting unit sets the receipt reject priority with respect to identifying information of the communication partner terminal other than the fixedly-retained identifying information of the communication partner terminals which should be rejected.

This scheme enables the identifying information of the predetermined communication partner terminal to be fixedly retained irrespective of the communication timestamp.

Moreover, the management system according to the invention further includes an information content comparing unit comparing, when performing the communication with the communication partner terminal specified by first identifying information, a content of information sent from the communication partner terminal with a content of information sent in the past from a communication partner terminal which should be rejected specified by second identifying information other than the first identifying information, wherein the priority setting unit, when the information content comparing unit judges that the contents of these pieces of information are coincident with each other, gives increased receipt reject priority to the first identifying information.

With this scheme, in such a case that the same communication partner terminal sends the information containing the same content while changing the identifying information of the terminal itself, it is feasible to give increased receipt reject priority to this communication partner terminal and to set the proper receipt reject priority, in other words, to retain the identifying information of adequate communication partner terminals.

Moreover, in the management system according to the invention, the priority setting unit, when the information content comparing unit judges that the contents of these pieces of information are coincident with each other, further gives decreased receipt reject priority to the second identifying information which is corresponding to communication partner terminal which should be rejected, other than the first identifying information.

With this scheme, in view of a low possibility that the identifying information before being changed is reused in such a case that the same communication partner terminal sends the information containing the same content while changing the identifying information of the terminal itself, it is feasible to give decreased receipt reject priority about the identifying information before being changed and to set the proper receipt reject priority, in other words, to properly retain the identifying information of the communication partner terminals which should be rejected.

Still further, the invention may be a method by which a computer or other device, machine, etc. executes any one of the processes. Moreover, the invention may also be a program for the compute or other device, machine, etc. actualize any one of the functions. The invention may further take a form that such a program is stored on a recording medium readable by the computer, etc.

According to the invention, the identifying information, exhibiting the higher priorities, of the communication partner terminals for the predetermined session count, is retained in accordance with the receipt reject priorities based on the communication timestamps, and it is therefore possible to properly manage the communication partner terminals which should be rejected, on the basis of the communication timestamps.

### DESCRIPTION OF THE DRAWINGS

FIG. 1 is a block diagram of an electronic mail system;

FIG. 2 is a diagram showing a flowchart of operations in a first embodiment;

FIG. 3 is a diagram showing one example of a process of updating a receipt reject address list in the first embodiment;

FIG. 4 is a diagram showing a flowchart of operations in a second embodiment;

FIG. 5 is a diagram showing one example of a process of calculating a reject priority in the second embodiment;

FIG. 6 is a diagram showing one example of the process of updating the receipt reject address list in the second embodiment;

FIG. 7 is a diagram showing one example of the process of calculating the reject priority in a third embodiment;

FIG. 8 is a diagram showing one example of the process of updating the receipt reject address list in the third embodiment;

FIG. 9 is a diagram showing a flowchart of a first operation in a fourth embodiment.

FIG. 10 is a diagram showing one example of the process of updating the receipt reject address list in the fourth embodiment; and

FIG. 11 is a diagram showing a flowchart of a second operation in the fourth embodiment.

### DETAILED DESCRIPTION OF THE INVENTION

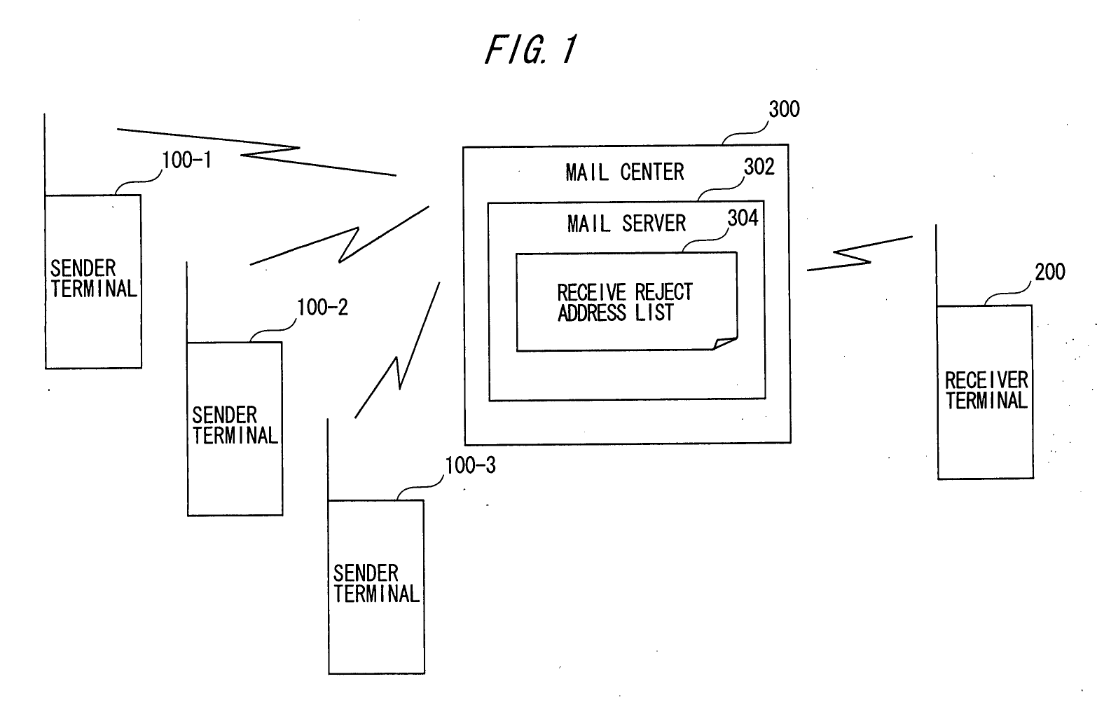

A management system in an embodiment of the invention will hereinafter be described with reference to the drawings. FIG. 1 shows a block diagram of an electronic mail system defined as a management system in the embodiment of the invention. Referring to FIG. 1, the electronic mail system includes sender terminals 100-1 through 100-3 (which will hereinafter be generically called “the sender terminals 100”) defined as terminals such as cellular phones, etc. that send E-mails, a receiver terminal 200 defined as a terminal such as a cellular phone, etc. that receives the E-mails, and a mail server 302 for controlling the transmissions and the receipts of the E-mails within a mail center 300. In the E-mail server 302, a storage unit (unillustrated) such as a memory, a hard disk, etc. retains a receipt reject address list 304 capable of registering a predetermined address count of mail addresses (receipt reject addresses) as pieces of identifying information of users of the sender terminals 100 or other sender terminals that have sent E-mails of which the receipts are rejected by the receiver terminal 200 (wherein the storage unit for retaining the address list 304 corresponds to a retaining unit).

Operations of the thus configured electronic mail system will be explained.

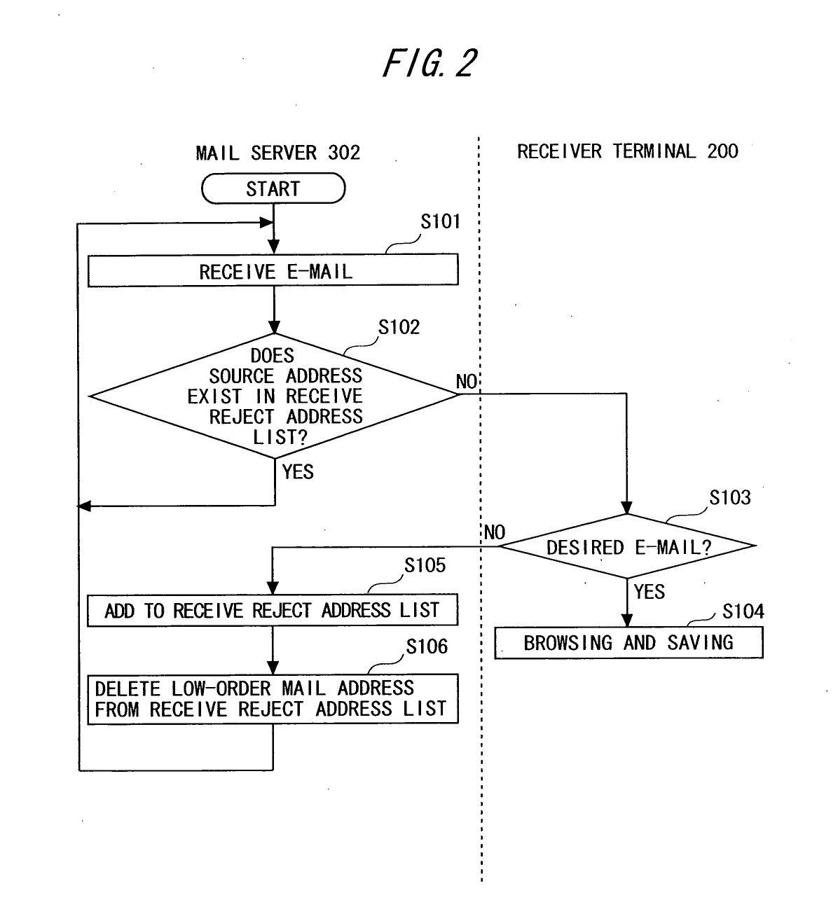

To start with, a first embodiment will be discussed. FIG. 2 shows a flowchart of the operations of the electronic mail system in the first embodiment.

The E-mail server 302 has an unillustrated CPU, an unillustrated memory, etc., and actualizes the following processes by executing a program loaded on the memory. To be specific, the E-mail server 302, upon receiving an E-mail addressed to the receiver terminal 200 from the sender terminal 100 (S101), judges whether a source address of this E-mail exists in the receipt reject address list 304 (S102). When the source address of the received E-mail exists in the receipt reject address list 304, the E-mail server 302 does not deliver, though receiving an E-mail delivery request from the receiver terminal 200, the E-mail having the source address as the E-mail address existing in the receipt reject address list 304 such as deleting this E-mail and so on. Thereafter, the E-mail server 302 redoes the operations subsequent to the receipt of the E-mail (S101).

On the other hand, the E-mail server 302, when the source address of the received E-mail does not exist in the receipt reject address list 304, delivers this E-mail in response to the E-mail delivery request given from the receiver terminal 200 The receiver terminal 200, upon receiving the thus delivered E-mail, judges whether this mail is an E-mail desired by the user or not (S103). For instance, the receiver terminal 200 boots mail Browser software in accordance with an operating instruction of the user, thereby displaying a list of the delivered E-mails on a display, etc. The user recognizes a source address and a subject of the delivered E-mail from this list, and thus judges whether this E-mail is a so-called nuisance E-mail or not. In the case of the nuisance E-mail, the user executes a predetermined operation for setting the source address of this nuisance E-mail as a receipt reject address through on the receiver terminal 200. Then, the receiver terminal 200, when the predetermined operation for setting the source address of the nuisance E-mail as the receipt reject address has been done, judges that the delivered E-mail is not the E-mail desired by the user.

The receiver terminal 200, when judging that the delivered E-mail is the E-mail desired by the user, executes a process of browsing the delivered E-mail and saves the data of the E-mail according to the user's operating instructions given thereafter (S104).

On the other hand, the receiver terminal 200, when judging that the delivered E-mail is not the E-mail desired by the user, sends a receipt reject request containing the mail source address of the delivered E-mail as a receipt reject address to the mail server 302. Upon receiving this receipt reject request, the mail server 302 adds, to the receipt reject address list 304, the receipt reject address contained in this receipt reject request, in other words, the mail source address of the E-mail that was not desired by the user of the receiver terminal 200 (S105, wherein the CPU of the mail server 302 executing this process corresponds to an identifying information registering unit).

Specifically, the mail server 302 stores the receipt reject address list 304 with a date/time (timestamp) when receiving the updated E-mail in a way that associates the timestamp with its mail address as a source address on an address-by-address basis. Then, the mail server 302, when adding the receipt reject address contained in the receipt reject request to the receipt reject address list 304, sorts out the mail addresses in the receipt reject address list 304 so that the mail addresses are arranged from a high-order in the sequence of the timestamp from the latest when the updated E-mail having the mail address as the source address is received by the mail server 302 (the CPU of the mail server 302, which executes this process, corresponds to a priority setting unit).

Moreover, the mail server 302 adds the mail address to the receipt reject address list 304 in S105 and, if a mail address of the mail which should be rejected, count exceeds a registerable mail address count in the receipt reject address list 304, deletes a low-order mail address, in other words, the mail source address of the E-mail that has been received earlier in terms of the latest receipt date/time in parallel with S105, thus setting the mail address count in the receipt reject address list 304 to the registerable mail address count (S106).

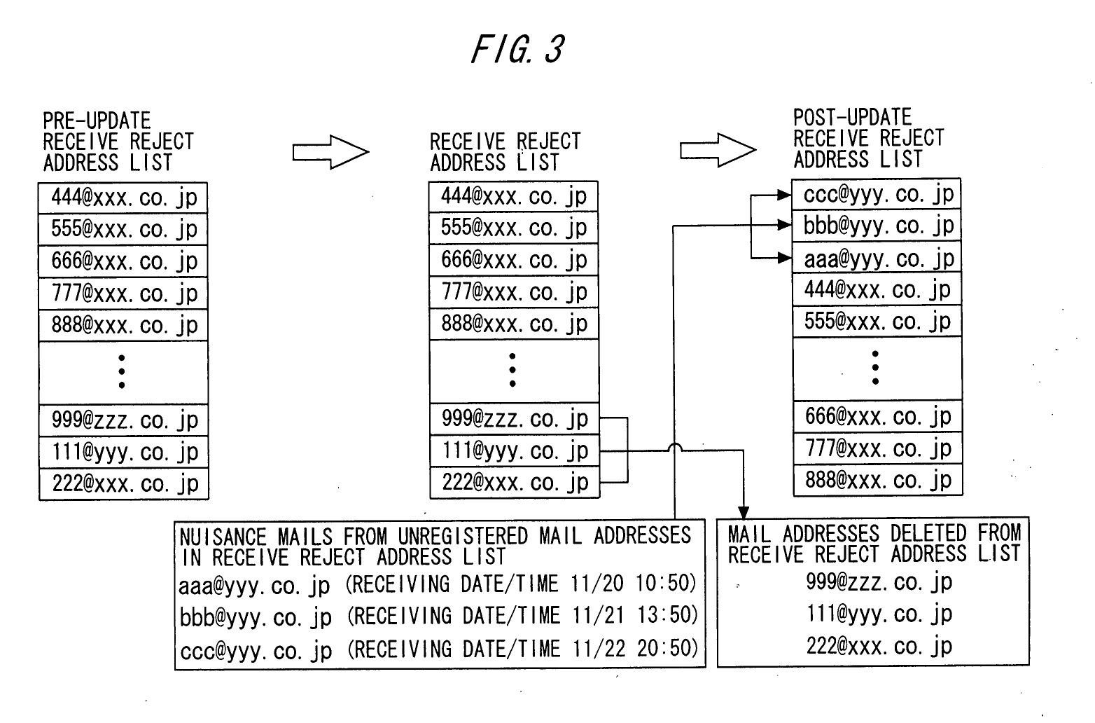

FIG. 3 shows one example of a process of updating the receipt reject address list 304 in S105 and in S106. Referring to FIG. 3, the receipt reject address list 304 before being updated is registered with a maximum count of registerable mail addresses. Those mail addresses are arranged from the higher order in the sequence of the latest date/time when the mail server 302 received the updated E-mail having that mail address as the source address.

In such a case, it is presumed that the mail server 302 receives, from the sender terminals 100, three E-mails having mail source addresses (aaa@yyy.co.jp, bbb@yyy.co.jp, ccc@yyy.co.jp) that do not exist in the receipt reject address list 304 and delivers those E-mails to the receiver terminal 200, and the receiver terminal 200 sends back a receipt reject request containing those E-mail source addresses as receipt reject addresses. In this case, the mail server 302 registers aaa@yyy.co.jp, bbb@yyy.co.jp, ccc@yyy.co.jp to give these addresses the higher-orders in the receipt reject address list 304. Hereat, the mail server 302 received the updated E-mail having aaa@yyy.co.jp as the source address at 10:50 on January 20th, the updated E-mail having bbb@yyy.co.jp as the source address at 13:50 on November 21st, and the updated E-mail having ccc@yyy.co.jp as the source address at 20:50 on November 22nd. Accordingly, the mail server 302 registers aaa@yyy.co.jp in the highest-order, bbb@yyy.co.jp next thereto and ccc@yyy.co.jp further next thereto in the receipt reject address list 304.

Moreover, when the three new mail addresses are thus registered, the mail address count exceeds the registerable mail address count in the receipt reject address list 304, and hence the mail server 302 deletes three lower-order mail addresses (999@zzz.cp.jp, 111@yyy.co.jp, 222@xxx.co.jp) from the receipt reject address list 304.

Thus, according to the first embodiment, in the view of such a high possibility that the mail source address of the recently time-stamped E-mail received by the mail server 302 is to become the source of the nuisance mail hereafter, the mail server 302, if the address count of the mail source addresses of the E-mails which should be rejected exceeds the registerable mail address count in the receipt reject address list 304, executes the control of registering the receipt reject address list 304 preferentially with the mail source address of the recently time-stamped E-mail received by the mail server 302. It is therefore possible to properly manage the mail addresses of the sender terminals 100 which should be rejected.

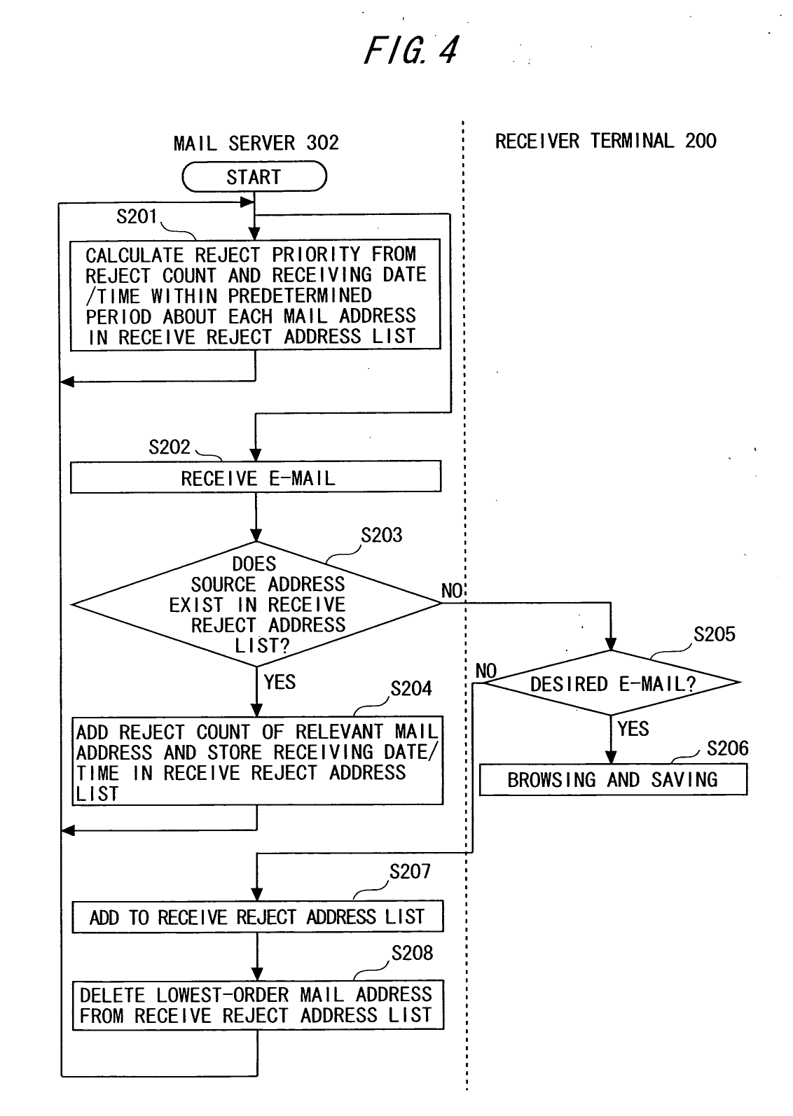

Next, a second embodiment will be discussed. FIG. 4 shows a flowchart of operations of the electronic mail system in the second embodiment.

The mail server 302 calculates a reject priority of each of the mail addresses existing in the receipt reject address list 304 on the basis of a mail count of the E-mails of which the receipts have been rejected within a predetermined period and the receipt date/time of each of the E-mails of which the receipts have been rejected (S201, wherein the CPU of the mail server 302, which executes this process, corresponds to a calculating unit).

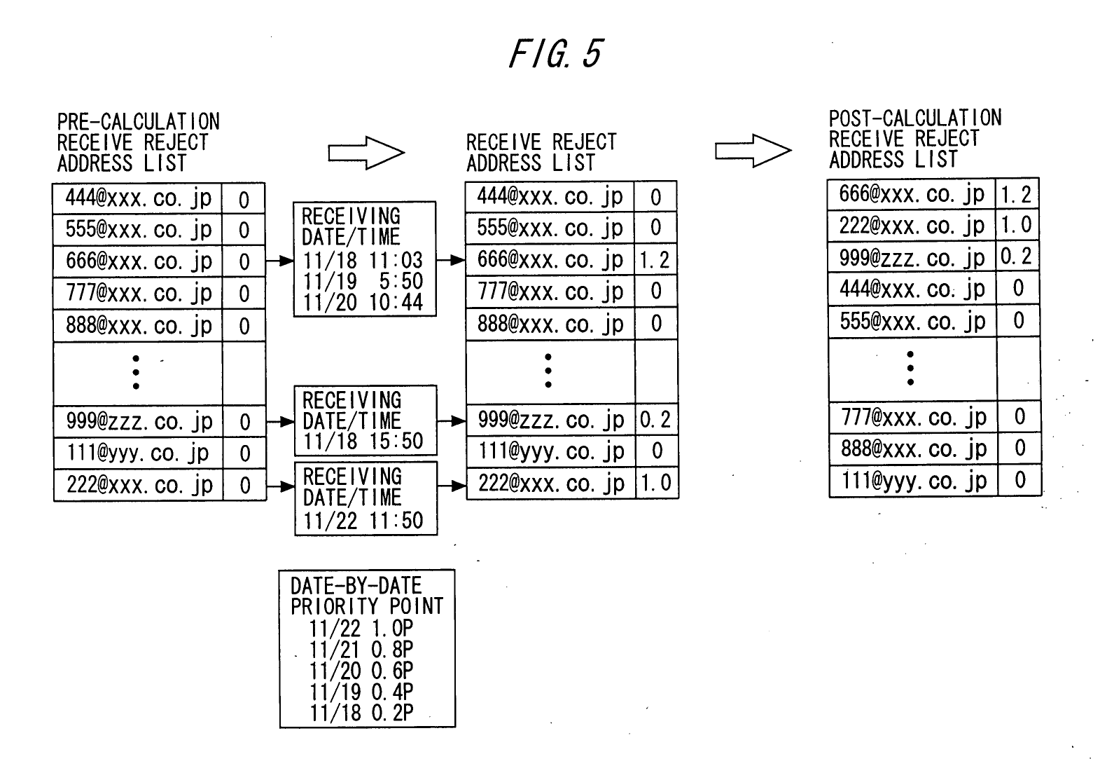

FIG. 5 shows one example of the process of calculating the reject priority in S201. Referring to FIG. 5, the pre-calculation receipt reject address list 304 is registered with the maximum count of registerable mail addresses. A point of the reject priority corresponding to each of those mail addresses is set to [0].

In such a case, it is presumed that the reject priority is calculated in accordance with a situation of receiving the E-mails over the past five days including the very receipt day. In this case, the mail server 302 calculates the reject priority, taking it into consideration that the point of the reject priority on a date-by-date basis is set to [1.0] on November 22nd (the very receipt day), the point is set to [0.8] on November 21st, the point is set to [0.6] on November 20th, the point is set to [0.4] on November 19th, and the point is set to [0.2] on November 18th. To be more specific, the E-mails having a source address [666@xxx.co.jp] were received at 11:13 on November 18th, at 5:50 on November 19th and at 10:44 on November 20th, and therefore the point of the reject priority about 666@xxx.co.jp is totally [1.2] as a sum of [0.2], [0.4] and [0.6]. Further, the E-mail having a source address [999@zzz.co.jp] was received at 15:50 on November 18th, and hence the point of the reject priority about 999@zzz.co.jp gains [0.2]. Still further, the E-mail having a source address [222@xxx.co.jp] was received at 11:50 on November 22nd, so that the point of the reject priority with respect to 222@xxx.co.jp becomes [1.0]. Moreover, the mail server 302 sorts out the mail addresses in the receipt reject address list 304 so that the addresses exhibiting higher reject priorities associated therewith are given higher-orders.

Further, the mail server 302, when receiving the E-mail addressed to the receiver terminal 200 from the sender terminal 100 in parallel with the derivation of the reject priority in S201 (S202), judges whether or not the source address of that E-mail exists in the receipt reject address list 304 (S203). The mail server 302, when the source address of the received E-mail exists in the receipt reject address list 304, adds a predetermined value (which is herein 1) to the mail count of the E-mails of which the receipts were rejected within the predetermined period with respect to each of the relevant mail addresses in the receipt reject address list 304, and stores the receipt date/time of the E-mail in S202 (S204) Thereafter, the mail server 302 redoes the operations after the derivation of the reject priority (S201) and the receipt of the E-mail (S202).

While on the other hand, when the source address of the received E-mail does not exist in the receipt reject address list 304, the mail server 302 delivers this E-mail in response to an E-mail delivery request given from the receiver terminal 200. The receiver terminal 200, upon receiving the E-mail delivered therefrom, judges whether it is the E-mail desired by the user or not (S205).

The receiver terminal 200, when judging that the delivered E-mail is the E-mail desired by the user, executes a process for browsing the delivered E-mail and saves the data of the E-mail (S206).

While on the other hand, the receiver terminal 200, when judging that the delivered E-mail is not the E-mail desired by the user, sends to the mail server 302 a receipt reject request containing the mail source address of the delivered E-mail as a receipt reject address. The mail server 302, when receiving this receipt reject request, adds to the receipt reject address list 304 a receipt reject address (which is a mail source address of the E-mail that was not desired by the user of the receiver terminal 200) contained in that receipt reject request (S207). A concrete adding procedure is the same as S105 in FIG. 3 according to the first embodiment. Moreover, if the address count of the mail addresses of the mail which should be rejected, exceeds the registerable address count in the receipt reject address list 304 as a result of adding the mail addresses to the receipt reject address list 304 in S207, the mail server 302 sets the mail address count in the receipt reject address list 304 to the registerable address count by deleting the lowest-order mail address, in other words, the mail source address of the oldest time-stamped E-mail in its latest receipt date/time in parallel with, S207 (S208).

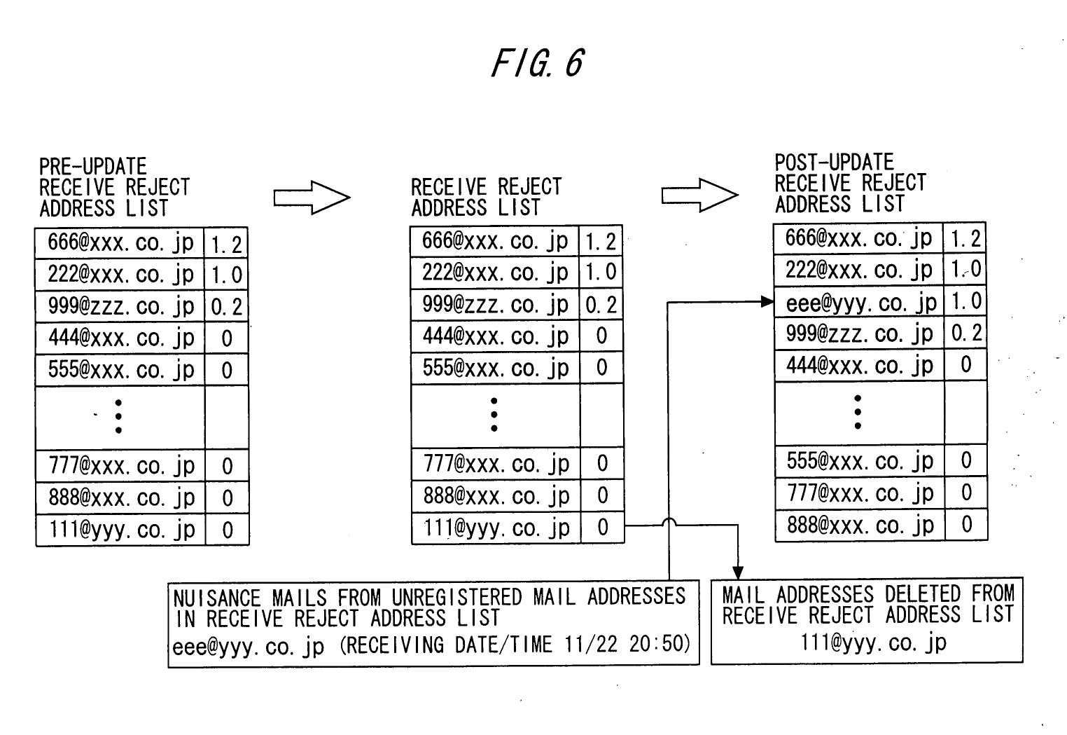

FIG. 6 shows one example of the process of updating the receipt reject address list 304 in S207 and in S208. Referring to FIG. 6, the pre-update receipt reject address list 304 is the same as the receipt reject address list 304 after calculating the reject priority in FIG. 5, wherein the mail addresses are sorted out so that the addresses exhibiting the higher reject priorities associated therewith are given the higher-orders.

In such a case, it is presumed that the mail server 302 receives from the sender terminal 100 an E-mail having a mail source address (eee@yyy.co.jp) that does not exist in the receipt reject address list 304 and delivers this mail to the receiver terminal 200, and the receiver terminal 200 sends a receipt reject request containing the source address of this E-mail as a receipt reject address. In this case, the mail server 302 sets a reject priority associated with eee@yyy.co.jp to [1.0] corresponding to the receipt on the very day. Next, the mail server 302 registers eee@yyy.co.jp in the receipt reject address list 304 so that the addresses exhibiting the higher reject priorities associated therewith are given higher-orders.

Moreover, when the new mail address is thus registered, the address count exceeds the registerable address count in the receipt reject address list 304, and consequently the mail server 302 deletes the lowest-order mail address (111@yyy.co.jp) out of the receipt reject address list 304.

As described above, according to the second embodiment, the mail server 302 calculates the reject priority for every mail source address of the E-mail on the basis of the date/time when receiving the E-mail. Further, if the mail source address count of the E-mails which should be rejected, exceeds the registerable address count in the receipt reject address list 304, the mail server 302 performs the control to register the mail address exhibiting the higher reject priority preferentially in the receipt reject address list 304. It is therefore possible to properly manage the mail addresses of the sender terminals 100 which should be rejected.

Next, a third embodiment will be discussed. According to the third embodiment, the mail server 302 does not deal with, as compared with the second embodiment, the predetermined mail addresses as the priority calculation targets, and sets these mail addresses in a state of being invariably registered in the receipt reject address list 304.

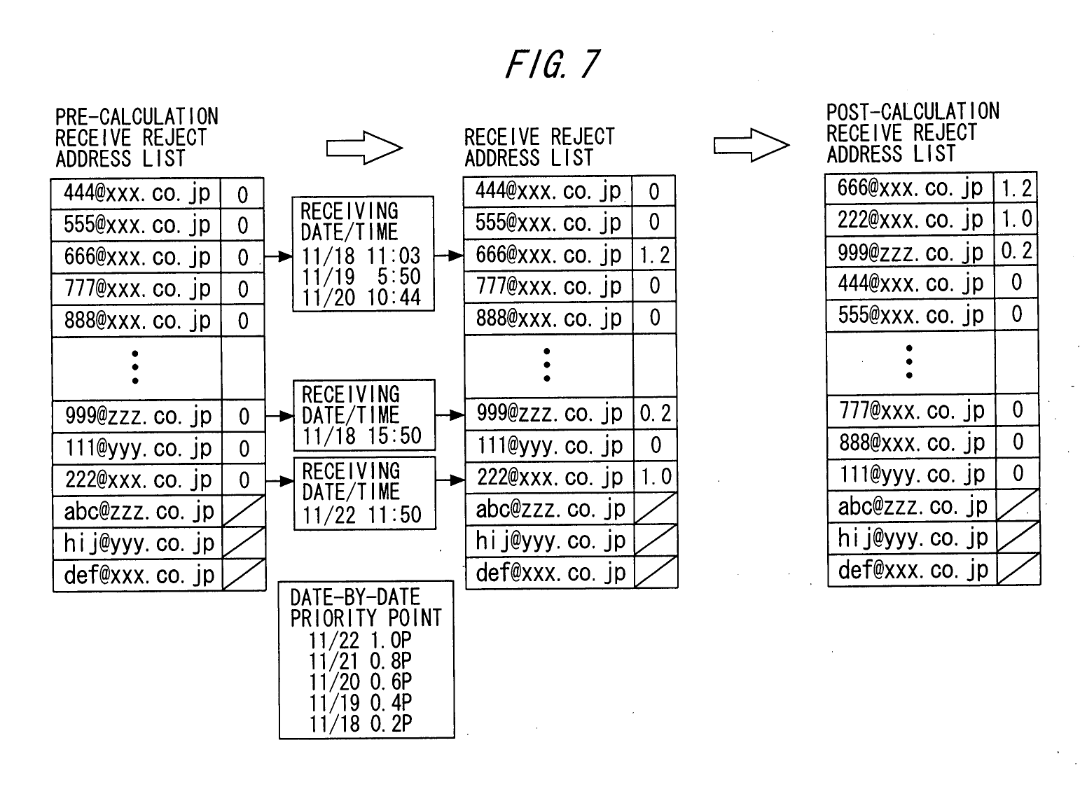

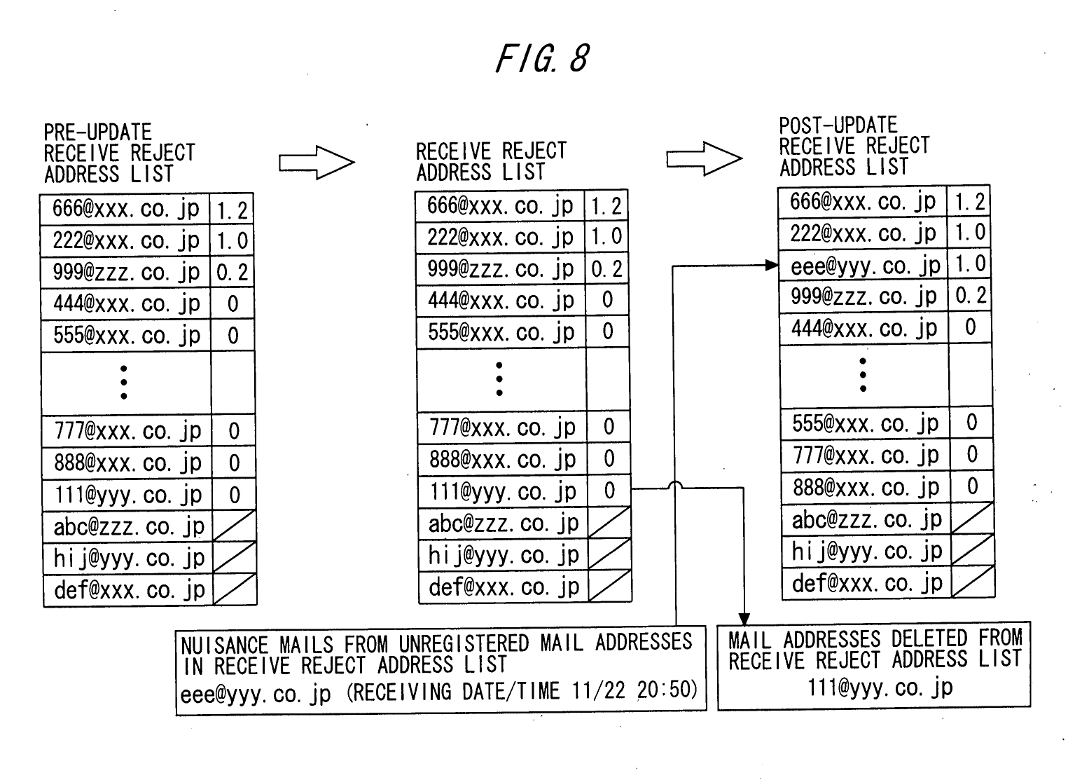

FIG. 7 shows one example of a process (corresponding to S201 in FIG. 4 in the second embodiment) of calculating the reject priority in the third embodiment. FIG. 8 shows one example of a process (corresponding to S207 and S208 in FIG. 4 in the second embodiment) of updating the receipt reject address list 304. Referring to FIG. 7, the pre-calculation receipt reject address list 304 is registered with a maximum count of registerable mail addresses. The mail server 302 does not deal with abc@zzz.co.jp. hij@yyy.co.jp, def@xxx.co.jp among those mail addresses as the reject priority calculation targets, and calculates the reject priorities of other mail addresses. Further, the mail server 302, even after updating the receipt reject address list 304 as shown in FIG. 8, sets the mail addresses in the state of being invariably registered in the receipt reject address list 304.

Thus, according to the third embodiment, the mail server 302 does not deal with the predetermined mail addresses as the reject priority calculation targets, and sets these mail addresses in the state of being invariably registered in the receipt reject address list 304. Accordingly, for example, the user can always reject the receipts of the mails having the strongly-desire-for-rejecting-the receipt mail addresses without depending on the reject priorities.

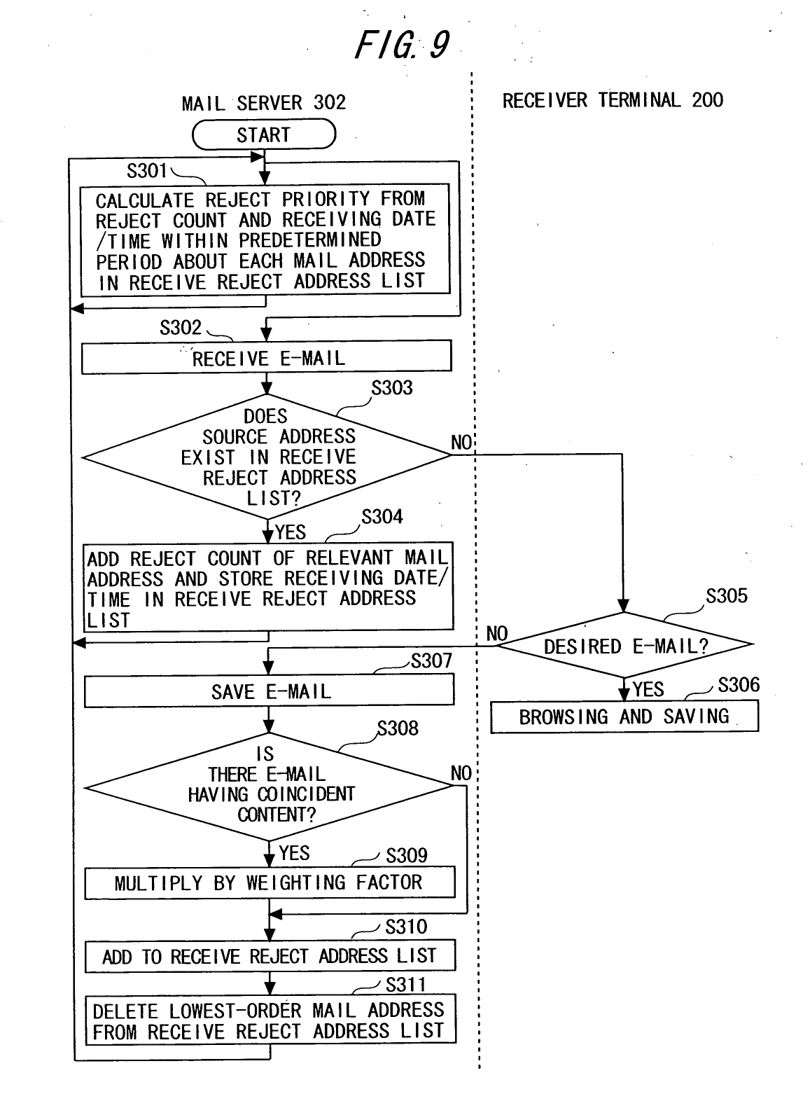

Next, a fourth embodiment will be discussed. FIG. 9 shows a flowchart of operations of the electronic mail system in the fourth embodiment. Note that the mail server 302 retains the data of the E-mails having the mail source addresses registered beforehand in the receipt reject address list 304 in FIG. 9.

Operations in S301 through S306 are the same as those in S201 through S206 in FIG. 4 according to the second embodiment, and hence their explanations are omitted.

The receiver terminal 200, when judging in S305 that the delivered E-mail is not the E-mail desired by the user, sends to the mail server 302 a receipt reject request containing a mail source address A (corresponding to first identifying information) of the delivered E-mail as a receipt reject address. The mail server 302, when receiving this receipt reject request, saves the data of the E-mail received in S302 (S307). Further, the mail server 302 judges whether or not the E-mail having a mail source address B registered in the pre-retained receipt reject address list 304 contains a content coincident with a content (e.g., a text) of the E-mail saved in S307 (S308, wherein the CPU of the mail server 302 executing this process corresponds to an information content comparing unit).

If the contents of the E-mails are coincident with each other, the mail server 302 multiplies the reject priority associated with the mail source address A of the E-mail saved in S307 by a predetermined weighting factor for enhancing the reject priority thereof in S307. At the same time, in S308, the mail server 302 multiplies the reject priority associated with a mail source address B (corresponding to second identifying information) of the E-mail of which the content is judged coincident with the content of the E-mail saved on S307 by a predetermined weighting factor for lowering the reject priority (S309).

After being multiplied by the weighting factor in S309, or after being judged negative in S308, the mail server 302 adds to the receipt reject address list 304 a receipt reject address (which is a mail source address of the E-mail that was not desired by the user of the receiver terminal 200) contained in the receipt reject request received from the receiver terminal 200 (S310). A specific adding procedure is the same as that in S105 in FIG. 3 according to the first embodiment. Moreover, if the address count of the mail addresses of the mail which should be rejected, exceeds the registerable address count in the receipt reject address list 304 as a result of adding the mail addresses to the receipt reject address list 304 in S310, the mail server 302 sets the mail address count in the receipt reject address list 304 to the registerable address count by deleting the lowest-order mail address, in other words, the mail source address of the oldest time-stamped E-mail in its latest receipt date/time in parallel with S310 (S311).

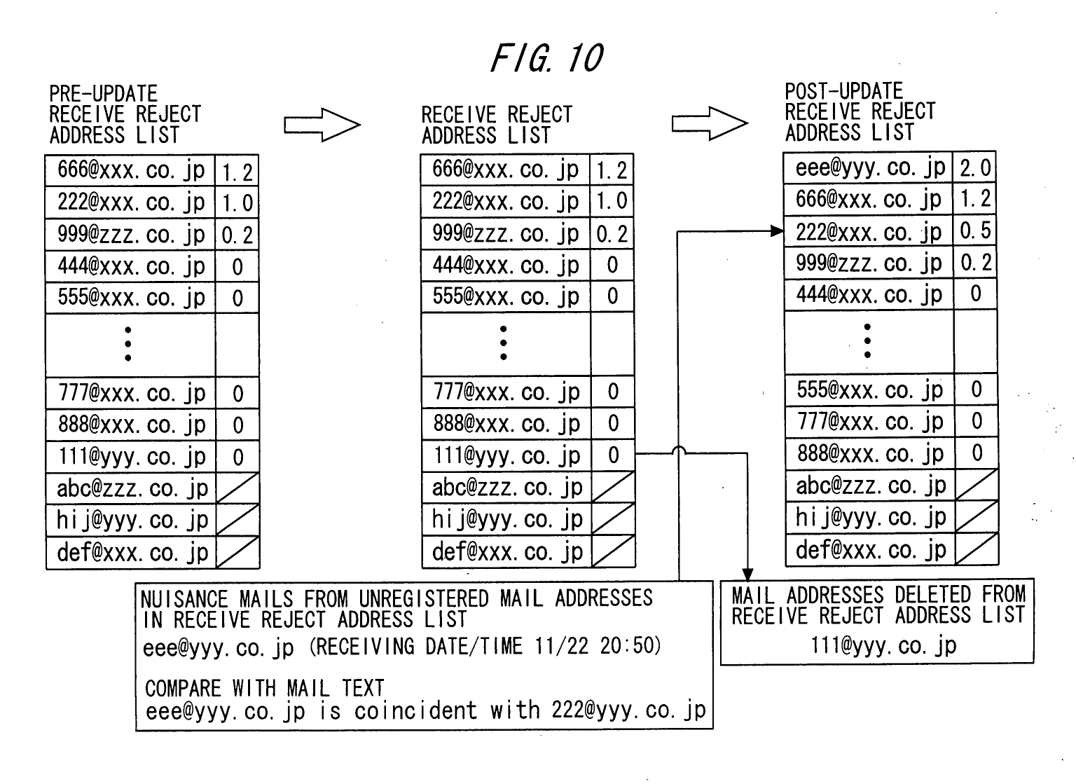

FIG. 10 shows one example of the process of updating the receipt reject address list 304 in S309 and in S311. Referring to FIG. 10, the pre-update receipt reject address list 304 is the same as the receipt reject address list 304 after calculating the reject priority in FIG. 7 in the third embodiment, wherein the mail addresses are sorted out so that the addresses exhibiting the higher reject priorities associated therewith are given the higher-orders.

In such a case, it is presumed that the mail server 302 receives from the sender terminal 100 an E-mail having a mail source address (eee@yyy.co.jp) that does not exist in the receipt reject address list 304 and delivers this mail to the receiver terminal 200, and the receiver terminal 200 sends a receipt reject request containing the source address of this E-mail as a receipt reject address. In this case, the mail server 302 sets a reject priority associated with eee@yyy.co.jp to [1.0] corresponding to the receipt on the very day. Next, the mail server 302 judges whether or not any one of the E-mails having mail source addresses registered in the pre-retained receipt reject address list 304 contains a content coincident with the content of the E-mail having the source address [eee@yyy.co.jp]. Herein, when judging that the content of the E-mail having the source address [eee@yyy.co.jp] is coincident with a content of an E-mail having a source address [222@yyy.co.jp](of which the reject priority is [1.0]) registered in the receipt reject address list 304, the mail server 302 multiplies the reject priority [1.0] associated with eee@yyy.co.jp by 2, resulting in [2.0]. At the same time, the mail server 302 sets the reject priority to [0.5] by multiplying the reject priority [1.0] associated with the address [222@yyy.co.jp] that has already been registered in the past. Next, the mail server 302 registers eee@yyy.co.jp in the receipt reject address list 304, and sorts out the mail addresses so that the addresses exhibiting the higher reject priorities associated therewith are given higher-orders.

Moreover, when the new mail address is thus registered, the address count exceeds the registerable address count in the receipt reject address list 304, and hence the mail server 302 deletes the lowest-order mail address (111@yyy.co.jp) from the receipt reject address list 304.

Thus, according to the fourth embodiment, in view of the case that the same party or the same sender terminal 100 keeps sending the E-mails having the same content in a way that changes the mail source address thereof when sending the nuisance mails, if the content of the received-and-saved E-mail is coincident with the content of the E-mail having any one of the mail source addresses registered in the receipt reject address list 304, the mail server 302 multiplies the reject priority associated with the mail source address of the received-and-saved E-mail by the predetermined weighting factor for enhancing the reject priority thereof. Further, in view of a low possibility that the already-used mail address is to be reused in the case wherein the same party or the same sender terminal 100 keeps sending the E-mails having the same content while changing the mail source address thereof when sending the nuisance mails, the mail server 302 multiplies the reject priority associated with the already-registered mail source address of the E-mail of which the content is judged coincident with the content of the received-and-saved E-mail by the predetermined weighting factor for lowering the reject priority thereof. With this scheme, it is feasible to calculate the proper reject priority, in other words, it is possible to properly manage the mail addresses of the sender terminals 100 which should be rejected.

Note that the mail server 302 saves the E-mail (S307), makes the comparison between the contents of the E-mails (S308) and multiplies by the weighting factor (S309) in FIG. 9, however, the receiver terminal 200 may also execute these processes (as far as S309 is concerned, the weighting factor is determined).

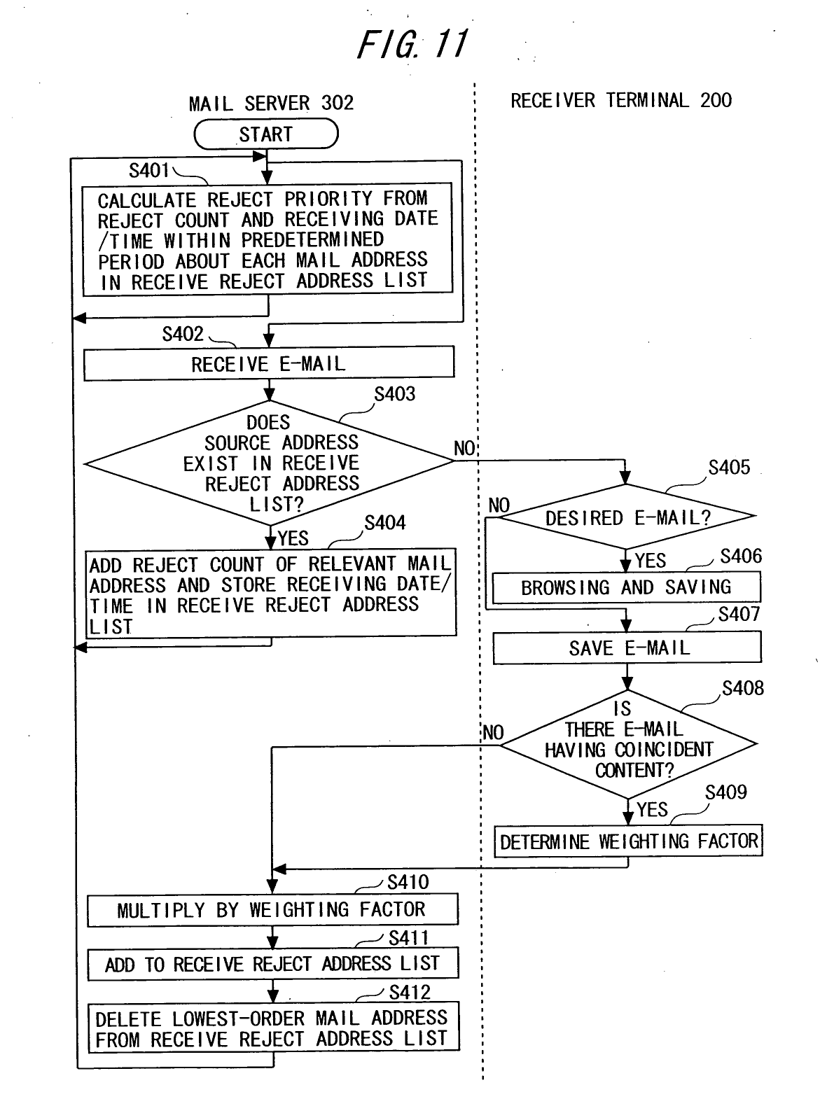

FIG. 11 shows a flowchart of operations of the electronic mail system in such a case that the receiver terminal 200 saves the E-mail, makes the comparison between the contents of the E-mails and multiplies by the weighting factor. Note that the mail server 302 retains the data of the E-mail having the mail source address previously registered in the receipt reject address list 304 in FIG. 11.

The operations in S401 through S406 are the same as those in S201 through S206 in FIG. 4 in the second embodiment, and hence their explanations are omitted.

The receiver terminal 200, when judging in S405 that the delivered E-mail is not the E-mail desired by the user, saves this delivered E-mail (S407). Further, the receiver terminal 200 judges whether or not any one of the E-mails having mail source addresses registered in the pre-retained receipt reject address list 304 contains a content coincident with the content of the E-mail saved in S407 (S408).

When the contents of the E-mails are coincident with each other, the receiver terminal 200 determines a given weighting factor for enhancing the reject priority associated with the mail source address of the E-mail saved in S407. At the same time, in S408, the receiver terminal 200 determines a given weighting factor for lowering the reject priority associated with the mail source address of the E-mail of which the content is judged coincident with the content of the E-mail saved in S407 (S409). Then, the receiver terminal 200 transmits a tuple of the determined weighting factor and the mail address associated with this weighting factor to the mail server 302.

The mail server 302, upon receiving the tuple of the weighting factor and the mail address, multiplies the reject priority associated with the mail source address of the E-mail received in S402 among the received mail addresses by the given weighting factor for enhancing the reject priority thereof, and at the same time multiplies a reject priority associated with a mail address other than the mail source address of the E-mail received in S402 among the received mail addresses by the given weighting factor for lowing the reject priority thereof (S410). The operations in S411 and S412 are the same as those in S310 and S311 in FIG. 9, and hence their explanations are omitted.

Note that the discussion on each of the embodiments has dealt with the case of sending and receiving the E-mails, however, the invention can be similarly applied also to communications via various types of telephones (in which a telephone number is identifying information) such as a fixed telephone, a cellular phone, etc. and FAX (in which a FAX number is identifying information).

Moreover, according to the fourth embodiment, as exemplified in FIG. 10, the predetermined mail addresses are not set as the reject priority calculation targets but set in the state of being invariably registered in the receipt reject address list 304 as in the third embodiment. Those fixed receipt reject addresses are not, however, provided, and, in the calculation of a point of the reject priority, the point may be weighted on all the mail addresses on the basis of a coincidence with the content of the E-mail received in the past.

Further, the embodiments have exemplified how the invention is carried out by the processes on the mail server 302 or by the processes of the receiver terminal 200 cooperating with the mail server 302. The embodiment of the invention is not, however, limited to this scheme. For instance, the processes of the mail server 302 may also be executed on a personal computer, the fixed telephone, the cellular phone, the FAX machine, a PDA, a VoIP (Voice over IP) network server and so on. Various categories of information devices such as the mail server 302, the receiver terminal 200, the personal computer, the fixed telephone, the cellular telephone, the FAX machine, the PDA, the VoIP network server, etc. correspond to the management system according to the invention.

<<Readable-by-Computer Recording Medium>>

A program for making a computer and other devices, machines, etc. actualize any one of the functions can be recorded on a recording medium readable by the computer, etc. Then, the computer reads and executes the program on this recording medium, thereby enabling the function thereof to be provided.

Herein, the recording medium readable by the computer, etc. connotes a recording medium capable of storing information such as data, programs, etc. electrically, magnetically, optically and mechanically or by chemical action, which can be read by the computer, etc.. Among those recording mediums, the mediums demountable out of the computer are, e.g., a flexible disk, a magneto-optic disk, a CD-ROM, a CD-R/W, a DVD, a DAT, an 8 mm tape, a memory card, etc.

Further, a hard disk, a ROM (Read Only Memory) and so on are classified as recording mediums fixed within the computer, etc.

1. A management system for managing communication partner terminals which should be rejected in communications, comprising:
a retaining unit retaining pieces of identifying information of the communication partner terminals which should be rejected in the communications for predetermined number of cases;
a priority setting unit setting, when a predetermined operation corresponding to a receipt rejection is performed, a receipt reject priority of the communication partner terminal's identifying information associated with the predetermined operation on the basis of a timestamp of the communication with the communication partner terminal; and
an identifying information registering unit retaining said retaining unit with the identifying information of the communication partner terminals for the predetermined number of cases in the order of descending the receipt reject priorities.

2. A management system according to claim 1, wherein said priority setting unit includes a calculation unit calculating numerical values associated with plural pieces of timestamps of communications with the communication partner terminals, and
said identifying information registering unit retains said retaining unit with the identifying information of the communication partner terminal corresponding to the predetermined operation for the predetermined number of the cases on the basis of the numerical value associated with the timestamp of communication.

3. A management system according to claim 1, wherein said retaining unit fixedly retains the identifying information of the communication partner terminals which should be rejected, and
said priority setting unit sets the receipt reject priority with respect to identifying information of the communication partner terminals other than the fixedly-retained identifying information of the communication partner terminals which should be rejected.

4. A management system according to claim 1, further comprising information content comparing unit for comparing, when performing the communication with the communication partner terminal specified by first identifying information, a content of information sent from the communication partner terminal with a content of information sent in the past from a communication partner terminal which should be rejected specified by second identifying information other than the first identifying information,
wherein said priority setting unit, when said information content comparing unit judges that the contents of these pieces of information are coincident with each other, gives increased receipt reject priority to the first identifying information.

5. A management system according to claim 4, wherein said priority setting unit, when said information content comparing unit judges that the contents of these pieces of information are coincident with each other, further gives decreased receipt reject priority to the second identifying information which is corresponding to communication partner terminal which should be rejected, other than the first identifying information.

6. A management method of managing communication partner terminals which should be rejected in communications, comprising:
getting retaining unit stored with pieces of identifying information of the communication partner terminals which should be rejected in the communications for predetermined number of cases;
setting, when a predetermined operation corresponding to a receipt rejection is performed, a receipt reject priority of the communication partner terminal's identifying information associated with the predetermined operation on the basis of a timestamp of the communication with the communication partner terminal; and
retaining said retaining unit with the identifying information of the communication partner terminals for the predetermined number of cases in the order of descending the receipt reject priorities.

7. A management method according to claim 6, when setting, calculating numerical values associated with plural pieces of timestamps of communications with the communication partner terminals, and
when retaining, retaining said retaining unit with the identifying information of the communication partner terminal corresponding to the predetermined operation for the predetermined number of the case on the basis of the numerical value associated with the timestamp of communication.

8. A management method according to claim 6, when retaining, fixedly retaining said retaining unit with the identifying information of the communication partner terminals which should be rejected, and
when setting, setting the receipt reject priority with respect to identifying information of the communication partner terminal other than the fixedly-retained identifying information of the communication partner terminals which should be rejected.

9. A management method according to claim 6, further comparing, when performing the communication with the communication partner terminal specified by first identifying information, a content of information sent from the communication partner terminal with a content of information sent in the past from a communication partner terminal which should be rejected specified by second identifying information other than the first identifying information,
when setting, when it is judged with comparing that the contents of these pieces of information are coincident with each other, giving increased receipt reject priority to the first identifying information.

10. A management method according to claim 9, when setting, when it is judged with comparing that the contents of these pieces of information are coincident with each other, further giving decreased receipt reject priority to the second identifying which is corresponding to communication partner terminal which should be rejected, other than the first identifying information.

11. A computer program running on a computer for making a computer manage communication partner terminals which should be rejected in communications, comprising:
instructions for getting retaining unit stored with pieces of identifying information of the communication partner terminals which should be rejected in the communications for predetermined number of cases;
instructions for setting, when a predetermined operation corresponding to a receipt rejection is performed, a receipt reject priority of the communication partner terminal's identifying information associated with the predetermined operation on the basis of a timestamp of the communication with the communication partner terminal; and
instructions for retaining said retaining unit with the identifying information of the communication partner terminals for the predetermined number of cases in the order of descending the receipt reject priorities.

12. A computer program according to claim 11, wherein said instructions for setting includes instructions for calculating numerical values associated with plural pieces of timestamps of communications with the communication partner terminals, and
said instructions for retaining involves retaining said retaining unit with the identifying information of the communication partner terminal corresponding to the predetermined operation for the predetermined number of the case on the basis of the numerical value associated with the timestamp of communication.

13. A computer program according to claim 11, wherein said instructions for retaining involves fixedly retaining said retaining unit with the identifying information of the communication partner terminals which should be rejected, and
said instructions for setting involves setting the receipt reject priority with respect to identifying information of the communication partner terminal other than the fixedly-retained identifying information of the communication partner terminals which should be rejected.

14. A computer program according to claim 11, further comprising instructions for comparing, when performing the communication with the communication partner terminal specified by first identifying information, a content of information sent from the communication partner terminal with a content of information sent in the past from a communication partner terminal which should be rejected specified by second identifying information other than the first identifying information,
wherein said instructions for setting involves, when it is judged by said instructions for comparing that the contents of these pieces of information are coincident with each other, giving increased receipt reject priority to the first identifying information.

15. A computer program according to claim 14, wherein said instructions for setting involves, when it is judged by said instructions for comparing that the contents of these pieces of information are coincident with each other, further giving decreased receipt reject priority to the second identifying which is corresponding to communication partner terminal which should be rejected, other than the first identifying information.
